(19) United States
(12) Patent Application Publication
(10) Pub. No.: US 2026/0302754 A1
(43) Pub. Date: Oct. 1, 2026

(54) IN-GROUND UTILITY ACCESS BOX AND RELATED METHODS

(71) Applicant: American Polymer Company, Pompano Beach, FL (US)

(72) Inventors: Scott Genovesi, Pompano Beach, FL (US); Sean Dvoran, Pompano Beach, FL (US); Ryan Wiborg, Pompano Beach, FL (US)

(21) Appl. No.: 19/706,126

(22) Filed: Jun. 12, 2026

Related U.S. Application Data
(63) Continuation-in-part of application No. 18/797,983, filed on Aug. 8, 2024.
(60) Provisional application No. 63/518,915, filed on Aug. 11, 2023.

(51) Int. Cl. H02G 9/10; E02D 29/14

(52) U.S. Cl. CPC H02G 9/10; E02D 29/1454

(57) ABSTRACT

A utility access vault may include a base and at least one sidewall extending vertically upward from the base. The at least one sidewall may define a cavity with an opening at a top thereof and a rim surrounding the opening, and it may be being flared inwardly from the base to the rim. The utility access vault may further include a plurality of ribs projecting outwardly from an outer surface of the at least one sidewall, with each of the plurality of ribs extending from the base toward the rim and being flared inwardly from the base toward the rim.

### RELATED APPLICATIONS

This application is a Continuation-in-Part of U.S. application Ser. No. 18/797,983 filed Aug. 8, 2024, which in turn claims the benefit of U.S. provisional application Ser. No. 63/518,915 filed Aug. 11, 2023, which are hereby both incorporated herein in their entireties by reference.

### TECHNICAL FIELD

The present disclosure generally relates to utility infrastructure, and more particularly to access boxes for utility infrastructure components and related methods.

### BACKGROUND

Various types of ground boxes or vaults are used to provide access points in a number of utility infrastructure applications. For example, pull boxes provide access to cables such as electrical or telecommunications lines. Other similar types of boxes provide access to valves, meters, and the like.

Such boxes are typically buried with the top of the box flush with the ground. A removable lid provides access to the infrastructure within when needed, and keeps the infrastructure otherwise closed off and protected when it is not. Various materials are used for such boxes, including concrete and polymer-based materials, for example.

### SUMMARY

A utility access vault may include a base and at least one sidewall extending vertically upward from the base. The at least one sidewall may define a cavity with an opening at a top thereof and a rim surrounding the opening, and it may be being flared inwardly from the base to the rim. The utility access vault may further include a plurality of ribs projecting outwardly from an outer surface of the at least one sidewall, with each of the plurality of ribs extending from the base toward the rim and being flared inwardly from the base toward the rim.

In an example implementation, the at least one sidewall has a circular cross-sectional shape. In another example implementation, the at least one sidewall may include a plurality of sides defining a rectangular cross-sectional shape.

Each of the plurality of ribs may project outwardly from the outer surface of the at least one sidewall by a substantially constant projection depth between the base and the rim, for example. In one implementation, the at least one sidewall defines a frusto-conical shape. Moreover, each side of the at least one sidewall may have a trapezoidal profile in elevation, with a wider dimension at the base and a narrower dimension at the rim.

In an example implementation, the plurality of ribs are equally spaced around the outer surface of the at least one sidewall. Each of the plurality of ribs may be integrally formed with the at least one sidewall. By way of example, each of the plurality of ribs may have one of a square, rounded, triangular, hexagonal, or pentagonal cross-sectional profile. In some example implementations, at least one fin may be positioned at an upper end of each rib. In another example implementation, the vault may further include at least one corner support fin at each corner of the at least one sidewall.

The base may define a webbed footer surrounding the cavity. In some implementations, the base and the at least one sidewall may define a unitary body. The utility access vault may further include a lid configured to close the opening when received by the rim.

A related method of manufacturing a utility access vault may include forming a base, at least one sidewall, and a plurality of ribs as a unitary body. The at least one sidewall may extend vertically upward from the base and define a cavity with an opening at a top thereof and a rim surrounding the opening. The at least one sidewall may be flared inwardly from the base to the rim, and each of the plurality of ribs may project outwardly from an outer surface of the at least one sidewall, extend from the base toward the rim, and be flared inwardly from the base toward the rim.

### BRIEF DESCRIPTION OF THE DRAWINGS

FIG. 1 is a perspective view of a utility access box in accordance with an example embodiment.

FIG. 2 is a side view of the utility access box of FIG. 1.

FIG. 3 is a cross-sectional view of the utility access box of FIG. 2 taken along the line A-A.

FIG. 4 is a top view of the utility access box of FIG. 1.

FIG. 5 is a bottom perspective view of the utility access box of FIG. 1.

FIG. 6 is a perspective view of two of the utility access boxes of FIG. 1 stacked one on top of another.

FIG. 7 is a side view of the stacked utility access boxes of FIG. 6.

FIG. 8 is a cross-sectional view of the stacked utility access boxes of FIG. 7 taken along line D-D.

FIG. 9 is a flow diagram illustrating a method for making a utility access box in accordance with an example embodiment.

FIG. 10 is a perspective view of a utility access box in accordance with another example embodiment having triangular ribs.

FIG. 11 is a top perspective view of a utility access box in accordance with another example embodiment having hexagonal ribs.

FIG. 12 is a top perspective view of a utility access box in accordance with another example embodiment having pentagonal ribs.

FIG. 13 is a top perspective view of a circular utility access vault in accordance with an example embodiment having rounded ribs.

FIG. 14 is a top perspective view of a circular utility access vault in accordance with another example embodiment having square ribs.

### DESCRIPTION

Example embodiments will now be described more fully hereinafter with reference to the accompanying drawings, in which the example embodiments are shown. The embodiments may, however, be implemented in many different forms and should not be construed as limited to the specific examples set forth herein. Rather, these embodiments are provided so that this disclosure will be thorough and complete. Like numbers refer to like elements throughout.

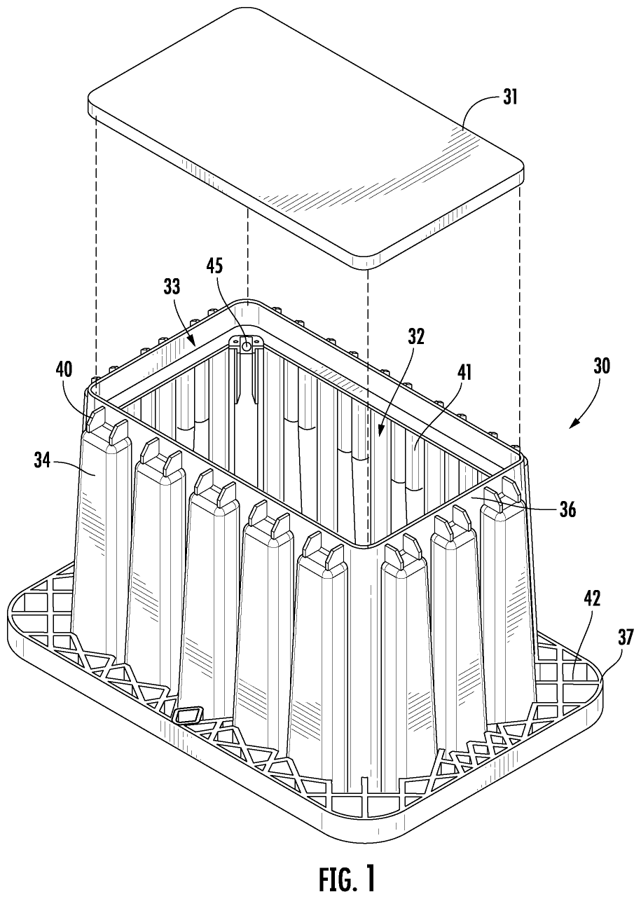

Referring initially to FIGS. 1-5, a utility access box or vault 30 in accordance with an example embodiment is first described. The box 30 is designed to be flush-mounted in the ground and receive a lid 31 in the top opening 32 illustrated in FIG. 1, which allows access to a cavity therein where the utility infrastructure is located (e.g., electrical wiring or components, telecommunications components, water/sewer components, traffic light components, meters, valves, etc.). Conventional lids 31 (e.g., polymer concrete, conventional concrete, etc.) may be used with the illustrated box 30, and in the illustrated configuration fits within the rimmed opening or rim 33 at the top of the box. As seen in FIG. 1, the lid 31 is sized to close the opening 32 when received by the rim 33.

Generally speaking, utility access boxes are positioned in locations where they may be subject to stress and heavy loads, such as along roadways. As such, they need to be sturdy enough to withstand such loads, which is why some of these boxes are made of concrete. However, transportation and storage of the boxes are also significant concerns, and thus lighter weight materials, such as polymer-based materials including high-density polyethylene (HDPE), are also used. A tiered scale is used to rate the strength of utility boxes, with tier 22 being the highest rating meant to withstand extreme loads such as being run over by a semi-tractor trailer.

The configuration of the illustrated box 30 provides a technical advantage of allowing fabrication from relatively light weight materials, such as HDPE (although other suitable materials may also be used, including concrete and polymer concrete or other polymer-based materials), while also providing enhanced structural stability high enough to achieve a tier 22 rating (although the present configuration may be used for lower-tiered box configurations as well). To achieve its structural rigidity, the box 30 illustratively includes outer (first) and inner (second) ribs 34, 35 along slanted or flared walls 36. In the present example, the exterior and interior ribs 34, 35 have a cross section resembling an elongated isosceles trapezoid (pyramids), although other shapes may be used in different embodiments (e.g., semi-cylindrical, triangular, etc.). As seen in FIGS. 1 and 5, the exterior and interior ribs 34, 35 alternate in an accordion-like or corrugated fashion, such that where the outer ribs protrude the inner ribs are recessed, and vice-versa. Moreover, the outer ribs 34 have their base (widest portion) at the bottom of the box 30, while the inner ribs 35 have their base at the top of the box (i.e., the exterior and interior ribs 34, 35 are inverted with respect to one another).

The sidewalls 36 of the box 30 extend vertically upward from a base 37 and are connected together to define the cavity therebetween and the opening 32 at a top of the box, with the rim 33 inside the opening. The exterior and interior ribs 34, 35 extend from the base 37 to the rim 33. More specifically, the exterior and interior ribs 34, 35 are in contact with and extend from the level of the base 37 all of the way up at least to the bottom level of the rim 33 in the illustrated example. Not only does this provide extra support and rigidity all of the way up the sides 36 of the box 30, but it also allows for extra reinforcement of the rim 33. Threaded inserts 45 or other suitable connectors may be included for securing the lid 31 (e.g., with screws, etc.).

In this regard, one or more exterior (first) fins 41 are positioned on the tops of the first ribs 34, and one or more interior (second) fins are carried on the interior fins 35. The exterior fins 40 are coupled to the sidewalls of the rim 33, while the interior fins 41 are coupled to the bottom of the rim, providing both lateral and vertical support to the rim when the cover 31 is under load. In the illustrated example, respective pairs of exterior fins 40 and interior fins 41 are carried by the exterior ribs 34 and interior ribs 35 for extra reinforcement and rigidity, although a single fin (or more than two fins) may be used on the exterior and/or interior in different embodiments. The ribs 34, 35 and fins 40, 41 advantageously provide desired structural stability or rigidity to help prevent excess deformity/bending of the box 30 under load, and achieve desired load ratings such as those noted above. Moreover, having the fins 40, 41 directly coupled to the ribs 34, 35 extends that structural stability to the rim 33 as well.

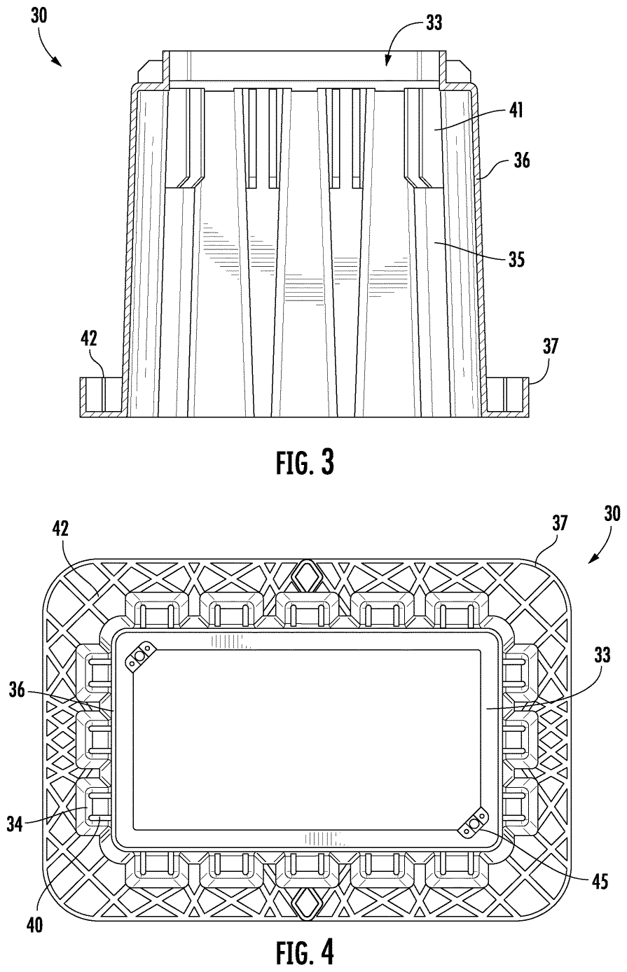

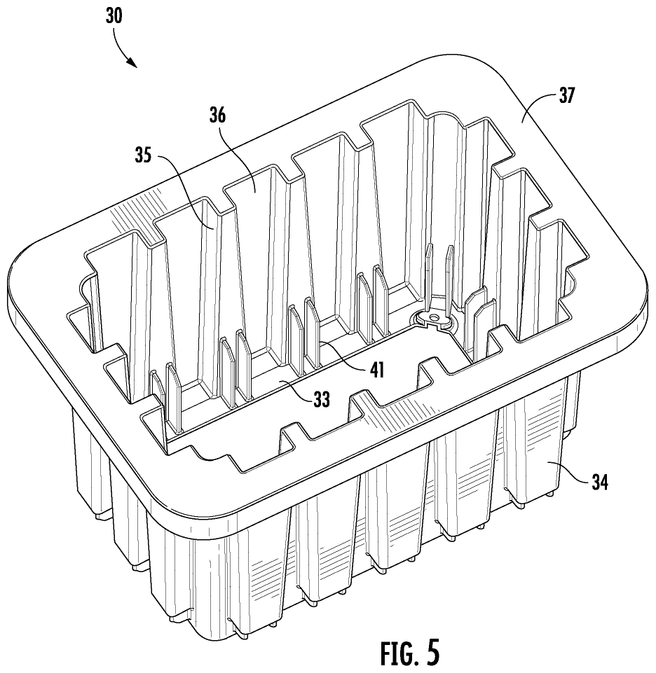

The base 37 of box 30 includes a webbed footer or footing 42 (FIG. 4), adding additional structural rigidity while helping to remove material to reduce weight. However, different footer configurations (e.g., solid, etc.) may also be used in different embodiments. It should be noted that the box 30 in the illustrated example is rectangular, but it may take other shapes (e.g., square, round, etc.) in different embodiments. Moreover, access boxes or vaults are known to come in a variety of different sizes for different applications, and the utility box described herein may be fabricated to accommodate such different sizes as well.

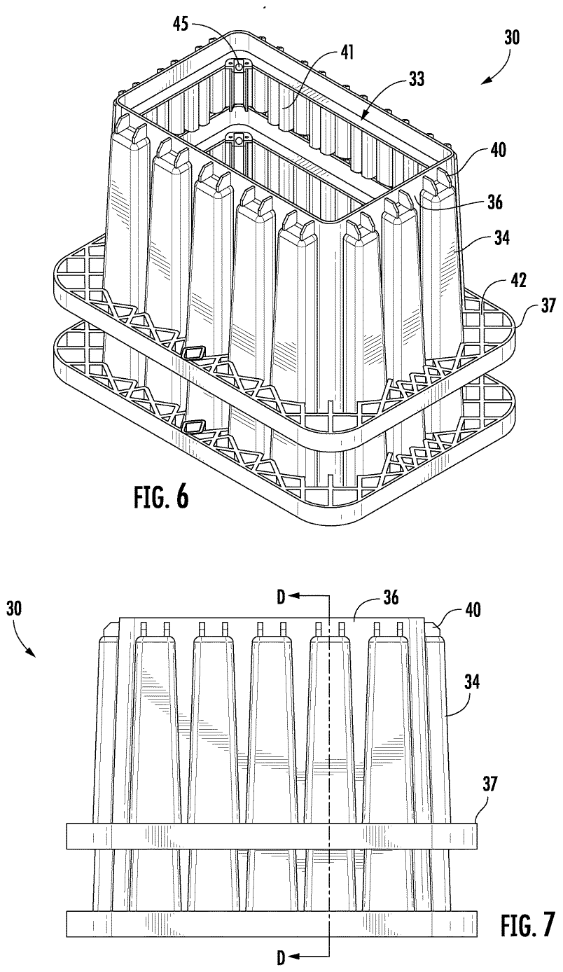

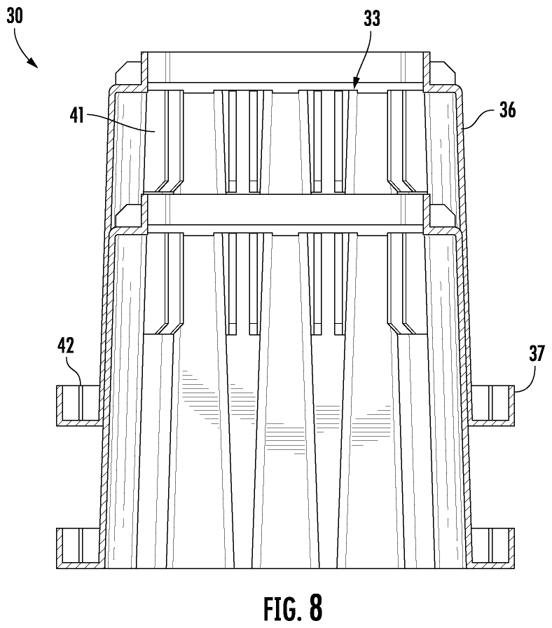

Another significant technical advantage of the utility box 30 is that it is a one-piece configuration which may be easily stacked for shipping and storage, as shown in FIGS. 6-8. The unitary, one-piece configuration is advantageous in that it requires less work to assemble in the field than a two-piece configuration, and may require less time to package for shipping. Moreover, less parts also reduces the chances of pieces getting lost or separated during shipping or storage, for example.

With regard to stacking, the flared walls 36 allow multiple boxes 30 to be stacked one on top of another as noted above. In addition, the interior fins 41 provide a stop that keeps the next box 30 in the stack from sliding all of the way down along the lower box, which allows the boxes to be more easily separated during unstacking. The above-described configuration, including the pyramid shape of the inner and outer ribs 34, 35, also helps provide a technical advantage of easier de-molding during the fabrication process, e.g., after injection molding.

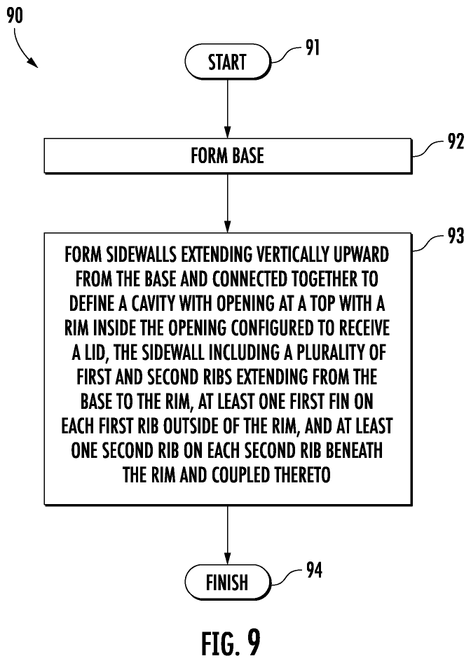

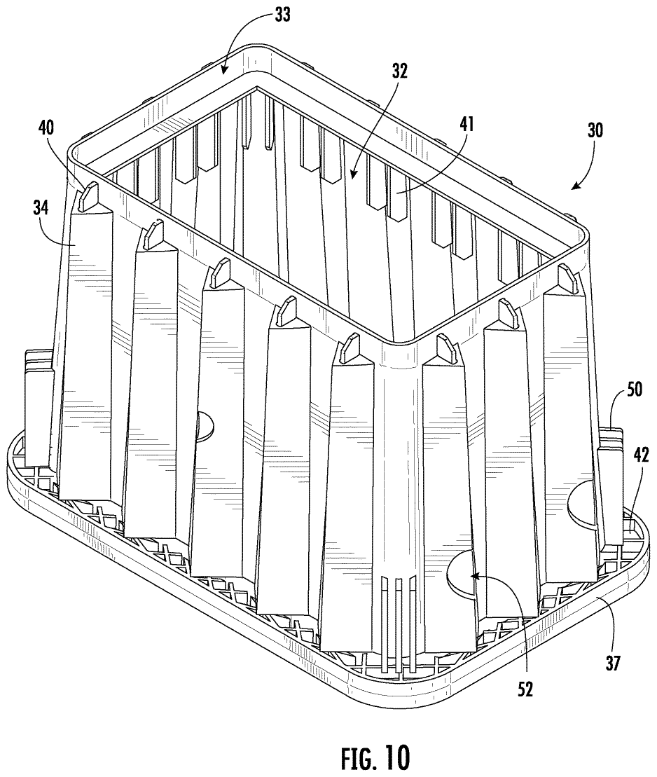

A related method for making the box 30 is now described with reference to the flow diagram 90 of FIG. 9. Beginning at Block 91, the method illustratively includes forming the base 37 and the plurality of sidewalls 36 extending vertically upward from the base, at Blocks 92-93. As discussed further above, the base 36 and sidewalls 36 may be integrally formed as a single, unitary body in a mold (e.g., from HPDE), although in some embodiments they could be formed as separate pieces. After demolding, the box 30 may be stacked with others for ease of storage and shipping, and its configuration allows for easy unstacking for deployment, as noted above. The method of FIG. 9 illustratively concludes at Block 94.

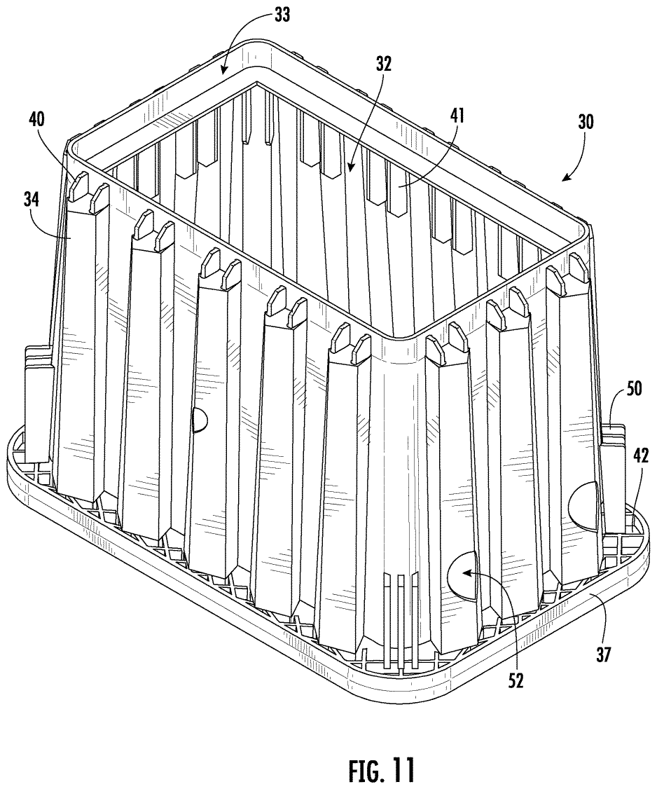

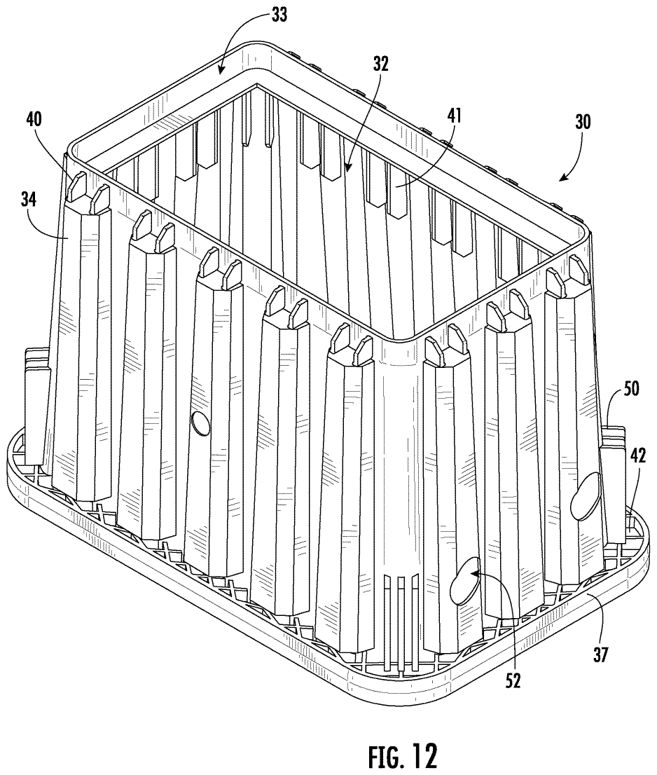

Referring now to FIGS. 10-12, additional example embodiments of box 30 are illustrated in which alternative rib geometries are employed. In these embodiments, the overall configuration of box 30—including the base 37, webbed footer 42, sidewalls 36, opening 32, and rim 33—is substantially the same as described above with reference to FIGS. 1-8. The primary distinction is in the cross-sectional profiles of the sidewall 36 and ribs 34. More particularly, in the embodiments of FIGS. 10-12, each sidewall 36 includes a plurality of ribs 34 each projecting outwardly from the outer surface of the sidewall. FIG. 10 illustrates an embodiment in which each rib 34 has a triangular cross-sectional profile, with the lateral faces of each rib converging toward one another in a direction away from the outer surface of the sidewall 36 to form an apex. FIG. 11 illustrates an embodiment in which each rib 34 has a hexagonal cross-sectional profile, and FIG. 12 illustrates an embodiment in which each rib 34 has a pentagonal cross-sectional profile. Other suitable rib cross-sectional profiles may also be used in further embodiments, such as square, rounded, or other polygonal geometries, as would be understood by one of ordinary skill in the art.

As with the ribs 34, 35 of the embodiment of FIGS. 1-8, the ribs 34 of FIGS. 10-12 each extend from the base 37 toward the rim 33. Fins 40 and 41 are optionally carried at the upper ends of the ribs 34, coupling the ribs to the rim 33 and providing lateral and vertical support thereto in the manner described above. As further shown in FIGS. 10-12, corner support fins 50 may optionally be provided at one or more corners of the sidewall 36 in rectangular vault embodiments, providing additional structural rigidity at the corner junctions where adjacent sidewalls meet and further enhancing the load-bearing capacity of the box 30 under vertical and lateral loads. Additionally, one or more access holes 52 may be formed in the sidewall 36 to accommodate utility cables, conduits, or other infrastructure components passing through the sidewall 36 into the cavity of the box 30. The access holes 52 may be provided on one or more sides and/or ends of the sidewall 36 as appropriate for different installations.

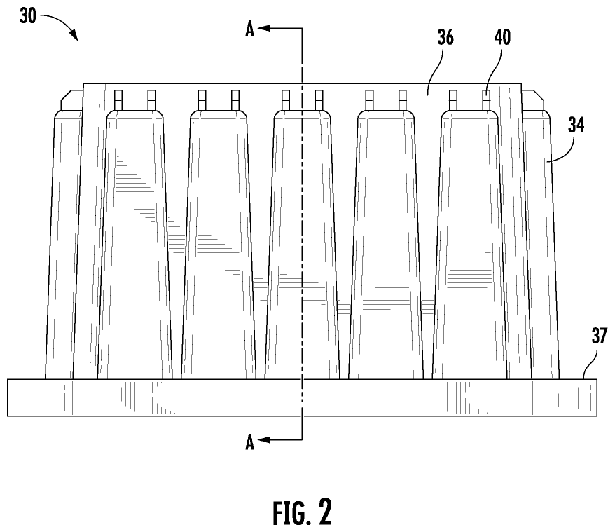

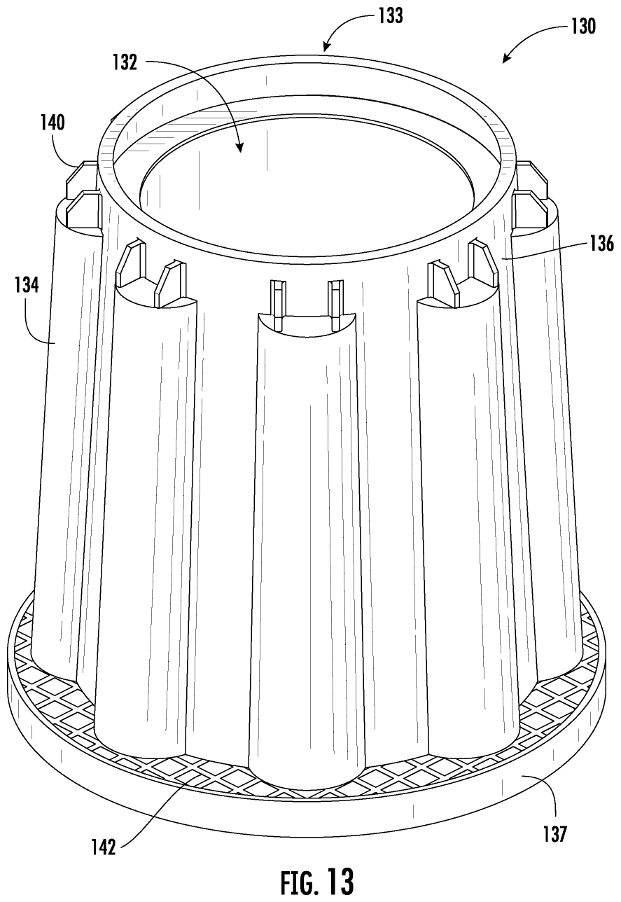

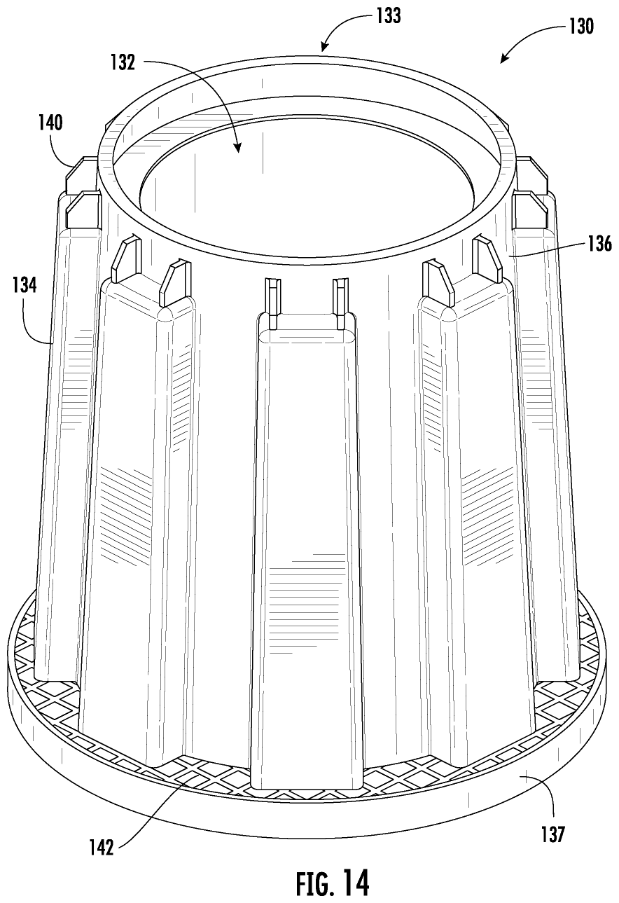

With reference more generally to the embodiments of FIGS. 1-12, an alternative structural characterization of the sidewall geometry of box 30 is helpful for understanding the broader aspects of the present disclosure and its extension to the additional embodiments described below with respect to FIGS. 13-14. As is evident from FIGS. 1-2 in particular, the sidewalls 36 of box 30 are flared inwardly from the base 37 to the rim 33. That is, the sidewalls 36 extend upward at an inward angle toward the central axis of the cavity, resulting in a wider cross-sectional dimension at the base 37 and a narrower cross-sectional dimension at the rim 33. In the illustrated embodiment, the sidewalls 36 are uniformly flared at a substantially constant angle relative to the central axis of the cavity, and each sidewall has a trapezoidal profile in elevation with a wider dimension at the base 37 and a narrower dimension at the rim 33.

Correspondingly, the ribs 34 (whether trapezoidal as in FIGS. 1-8, triangular as in FIG. 10, hexagonal as in FIG. 11, or pentagonal as in FIG. 12) are also flared inwardly from the base 37 toward the rim 33 in correspondence with the inward flare of the sidewalls 36. More specifically, the outermost extent of each rib 34 tracks the same inward draft angle as the outer surface of the sidewall 36 relative to the central axis of the cavity, such that the ribs 34 and sidewall 36 are co-flared along a common draft trajectory. In embodiments where the rib 34 has a flat outer face—such as the square, hexagonal, and pentagonal cross-sectional profiles—the outer face of each rib is substantially parallel to the outer surface of the sidewall 36. In embodiments where the rib 34 has a non-planar outer profile —such as the triangular cross-sectional profile, in which the lateral faces converge to an apex, or the rounded cross-sectional profile, in which the outer surface is curved—the apex or outermost point of each rib 34 similarly follows the same inward draft trajectory as the outer surface of the sidewall 36.

As a consequence of this co-flared geometry, each rib 34 projects outwardly from the outer surface of the sidewall 36 by a substantially constant projection depth along its height from the base 37 to the rim 33. The lateral faces of each rib 34 additionally converge toward each other in a direction away from the outer surface of the sidewall 36, a feature present in both the trapezoidal ribs of FIGS. 1-8 and in the triangular, hexagonal, and pentagonal ribs of FIGS. 10-12. Together, the inward flare of the sidewalls 36 and ribs 34 defines a continuous draft surface on the exterior of the box 30 that permits removal of the box from a mold in a single withdrawal along the central axis of the cavity, thereby further facilitating the one-piece molding process described herein.

Turning now to FIGS. 13-14, the structural and manufacturing advantages described above with reference to the rectangular vault embodiments of FIGS. 1-12 may also be realized in vaults having a circular sidewall geometry. FIGS. 13 and 14 illustrate a utility access vault 130 in accordance with additional example embodiments. The vault 130 includes a base 137 and a sidewall 136 having a circular cross-sectional shape extending vertically upward from the base 137. The sidewall 136 defines a cavity with an opening 132 at a top thereof and a rim 133 surrounding the opening 132 and configured to receive a lid. A webbed footer 142 surrounds the lower portion of the cavity at the base 137, providing additional structural rigidity while reducing weight, in the manner described above for the rectangular embodiment.

Like the sidewalls 36 of box 30, the sidewall 136 of vault 130 is flared inwardly from the base 137 to the rim 133. In circular embodiments, this inward flare results in the sidewall 136 defining a frusto-conical shape. That is, the result is the shape of a truncated cone, with a wider circular cross-sectional dimension at the base 137 and a narrower circular cross-sectional dimension at the rim 133. Ribs 134 project outwardly from the outer surface of the sidewall 136. In the illustrated examples, the ribs 134 are equally spaced circumferentially around the outer surface of the sidewall 136, and each rib 134 extends radially outward from the outer surface of the sidewall 136. The ribs 134 are co-flared with the sidewall 136 in the same manner described above for the rectangular embodiments. That is, each rib 134 is flared inwardly from the base 137 toward the rim 133 in correspondence with the frusto-conical taper of the sidewall 136, and both the sidewall 136 and each rib 134 taper co-axially toward the central axis of the vault 130 from the base 137 to the rim 133. As with the rectangular embodiments, the outer faces of the ribs 134 and the outer surface of the sidewall 136 together define a continuous draft surface that permits removal of the vault 130 from a mold in a single axial withdrawal along the central axis of the vault.

Each rib 134 extends from the base 137 toward the rim 133, and may optionally include one or more fins 140 at an upper end of the rib body. The fins 140 extend from the upper end of the rib adjacent the rim 133, coupling the rib 134 to the rim 133 and providing structural support thereto in a manner analogous to the fins 40 of the rectangular embodiments described above. Although not shown in FIGS. 13-14, internal fins (similar to the fins 41 described above) may also be provided on the interior of the sidewall as well in some embodiemnts.

FIG. 13 illustrates an embodiment of vault 130 in which each rib 134 has a rounded or conical cross-sectional profile, and FIG. 14 illustrates an alternative embodiment of vault 130 in which each rib 134 has a square cross-sectional profile. Other cross-sectional profiles may also be used with the circular vault 130 in further embodiments, including triangular, hexagonal, pentagonal, or other suitable geometries, in the same manner as described above for the rectangular embodiments. Similarly, the rounded and square rib profiles illustrated in FIGS. 13-14, as well as the triangular, hexagonal, and pentagonal profiles of FIGS. 10-12, may each be used with either rectangular or circular vault configurations as would be understood by one of ordinary skill in the art.

It should also be noted that in some embodiments different sizes and/or shapes of ribs may be used along the sidewall. For example, larger ribs along the sides and smaller ribs along the ends of the sidewall 36, for example. Another alternative would be alternating size rib (e.g., small-large-small-large, etc.), or alternating rib shapes (e.g., triangular-circular-triangular-circular, etc.). Numerous different combinations and possibilities will be appreciated by those skilled in the art. Moreover, it should also be appreciated that different sidewall geometries besides square/rectangular/circular may also be used in different embodiments. For example, the cross-sectional shape of the sidewall may be a triangle, pentagon, hexagon, etc. in different embodiments.

With regard to manufacturing, the vaults 130 of FIGS. 13-14 may be fabricated in the same general manner as box 30 of FIGS. 1-9. In particular, the base 137, sidewall 136, and ribs 134 may be integrally formed as a single, unitary body by molding. For example, this may be done by injection molding from HDPE or other suitable polymer-based or other materials. The co-flared geometry of the sidewall 136 and ribs 134 permits the unitary body to be removed from the mold in a single withdrawal along the central axis of the vault 130, as described above. The frusto-conical shape of the sidewall 136 also allows multiple vaults 130 to be stacked one on top of another for efficient storage and shipping, in a manner analogous to the stacking of box 30 described above with reference to FIGS. 6-8. The foregoing manufacturing considerations apply equally to the rectangular embodiments of FIGS. 10-12 as described herein.

Many modifications and other embodiments of the invention will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. A utility access vault comprising:
a base;
at least one sidewall extending vertically upward from the base, the at least one sidewall defining a cavity with an opening at a top thereof and a rim surrounding the opening, the at least one sidewall being flared inwardly from the base to the rim; and
a plurality of ribs projecting outwardly from an outer surface of the at least one sidewall, each of the plurality of ribs extending from the base toward the rim and being flared inwardly from the base toward the rim.

2. The utility access vault of claim 1, wherein the at least one sidewall has a circular cross-sectional shape.

3. The utility access vault of claim 2, wherein the at least one sidewall defines a frusto-conical shape.

4. The utility access vault of claim 1, wherein the at least one sidewall comprises a plurality of sides defining a rectangular cross-sectional shape with corners between the sides.

5. The utility access vault of claim 4, further comprising at least one corner support fin at each corner.

6. The utility access vault of claim 4, wherein each side of the at least one sidewall has a trapezoidal profile in elevation, with a wider dimension at the base and a narrower dimension at the rim.

7. The utility access vault of claim 1, wherein each of the plurality of ribs projects outwardly from the outer surface of the at least one sidewall by a substantially constant projection depth between the base and the rim.

8. The utility access vault of claim 1, wherein the plurality of ribs are equally spaced around the outer surface of the at least one sidewall.

9. The utility access vault of claim 1, wherein each of the plurality of ribs is integrally formed with the at least one sidewall.

10. The utility access vault of claim 1, wherein each of the plurality of ribs has one of a triangular, hexagonal, or pentagonal cross-sectional profile.

11. The utility access vault of claim 1, wherein each of the plurality of ribs has a square cross-sectional profile.

12. The utility access vault of claim 1, wherein each of the plurality of ribs has a rounded cross-sectional profile.

13. The utility access vault of claim 1 further comprising at least one fin at an upper end of each rib adjacent the rim.

14. The utility access vault of claim 1, wherein the base comprises a webbed footer surrounding the cavity.

15. The utility access vault of claim 1, wherein the base and the at least one sidewall define a unitary body.

16. The utility access vault of claim 1, further comprising a lid configured to close the opening when received by the rim.

17. A utility access vault comprising:
a base;
a sidewall having a circular cross-sectional shape extending vertically upward from the base, the sidewall defining a cavity with an opening at a top thereof and a rim surrounding the opening, the sidewall being flared inwardly from the base to the rim; and
a plurality of ribs projecting outwardly from an outer surface of the sidewall, each of the plurality of ribs comprising a rib body extending from the base toward the rim and being flared inwardly from the base toward the rim, and at least one fin at an upper end of the rib body, the at least one fin coupling the upper end of the rib body to the rim.

18. The utility access vault of claim 17, wherein the sidewall defines a frusto-conical shape.

19. The utility access vault of claim 17, wherein each of the plurality of ribs has a rounded cross-sectional profile.

20. The utility access vault of claim 17, wherein each of the plurality of ribs has a square cross-sectional profile.

21. The utility access vault of claim 17, wherein the at least one fin extends laterally from the upper end of the rib body in a plane substantially co-planar with the rim.

22. A method of manufacturing a utility access vault comprising:
forming a base, at least one sidewall, and a plurality of ribs as a unitary body, wherein the at least one sidewall extends vertically upward from the base and defines a cavity with an opening at a top thereof and a rim surrounding the opening, the at least one sidewall being flared inwardly from the base to the rim, and each of the plurality of ribs projects outwardly from an outer surface of the at least one sidewall, extends from the base toward the rim, and is flared inwardly from the base toward the rim.

23. The method of claim 22, wherein forming the unitary body comprises molding the base, the at least one sidewall, and the plurality of ribs in a single mold withdrawal along a central axis of the cavity.

24. The method of claim 22, wherein the at least one sidewall is formed with a circular cross-sectional shape.

25. The method of claim 22, wherein forming the at least one sidewall comprises forming a plurality of sides defining a rectangular cross-sectional shape with corners between the sides.
